(19) United States
(12) Patent Application Publication
(10) Pub. No.: US 2008/0090214 A1
(43) Pub. Date: Apr. 17, 2008

(54) Burn building for training firefighters

(76) Inventor: Jerome F. D'Anneo, Kingston, NY (US)

Correspondence Address: JOHN MAIER, III, 660 AARON COURT, KINGSTON, NY, 12401, US

(21) Appl. No.: 11/541,125

(22) Filed: Oct. 2, 2006

(51) Int. Cl. G09B 19/00

(52) U.S. Cl. 434/226

(57) ABSTRACT

A burn building for training firefighters includes a burn room with a ceiling and at least one building entry into the burn room. The burn room has at least one exterior wall where a heat generation unit is mounted, and the heat generation unit is directed into the burn room. A barrier panel in the burn room permits exposing and covering the heat generation unit. The barrier panel is raised and lowered by air operated pistons and cylinders. The heat generation unit is operated from a control panel. A rack is suspended from the ceiling to hold wood pallets which generate smoke when heated to combustion temperature. A light is located at the building entry to indicate when to enter the burn building and the burn room.

### BACKGROUND OF THE INVENTION

1. Field of the Invention

This invention relates to burn buildings used for training firefighters and more specifically, to a burn building in which both temperature and smoke conditions are controlled.

2. Prior Art

Burn buildings are used to train firefighters under realistic conditions while providing reasonable safety conditions. A burn building is constructed of cement block with a cement floor and ceiling. Preferably, in some cases in the past, straw was used to start a fire in a burn room. Numerous other possible combustible materials have been used for the setting of allegedly controlled fires in burn rooms. Such fires have not produced with reasonable accuracy, the temperature for the burn situation that is desired. Burn buildings are must be capable of achieving a temperature of six hundred degrees Fahrenheit at the ceiling. Previously, temperature was hard, if not impossible, to control. Only too frequently, the desired temperature level was not achieved.

In order to achieve proper and comparatively safe conditions for the training of firefighters, it is essential that a burn room ng constructed where temperature can be controlled and where smoke conditions are predictable.

### OBJECTS

The objects of the invention are to provide as follows:

1. A burn room where predetermined heat and smoky conditions can be achieved.

2. A burn room where the time required to cool the fire to below the kindling temperature can be determined.

3. A burn room with a high level of safety for those being trained in the burn room for efficiently controlling hostile fire conditions.

Other objects, advantages, and capabilities of the invention will become apparent from the foregoing description together and in conjunction with the accompanying drawings showing the preferred embodiments of the invention.

### SUMMARY OF THE INVENTION

A burn building is provided for training firefighters. The burn room is located in a burn building with a ceiling and having at least one doorway into the burn room. A heat generation unit is directed into the burn room. A barrier panel is located in the burn room for exposing and covering the heat generation unit. The barrier panel is opened and closed pneumatically. The heat generation unit is operated from a control panel. A rack is suspended from the ceiling. A means is provided to indicate when to enter the burn room.

### BRIEF DESCRIPTION OF THE DRAWINGS

FIG. 1 is a floor plan of a burn room showing the building entry for firefighters.

FIG. 2 is a graph of time versus temperature in a burn room with a preset oil flow to an oil burner used to heat the burn room.

FIG. 3 is a pictorial view of the burn building showing the oil burner outside of the burn building.

FIG. 4 is a rear elevation of the oil burner enclosure with the access door open showing the oil burner within the enclosure.

FIG. 5 is a front elevation of the oil burner enclosure from within the burn room with the barrier panel of the burner enclosure closed.

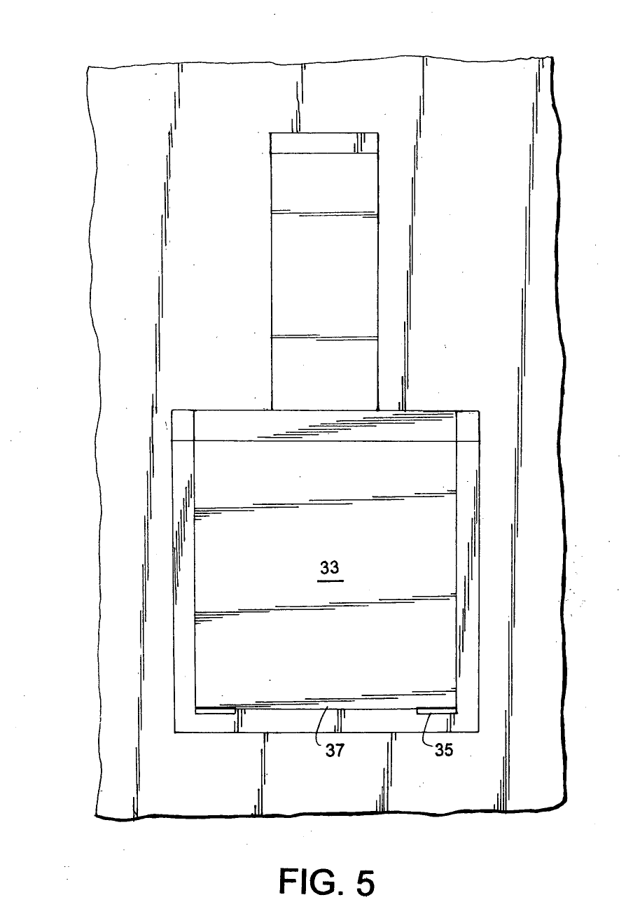

FIG. 6 is a pictorial view of a wood pallet rack mounted on the ceiling of the burn room.

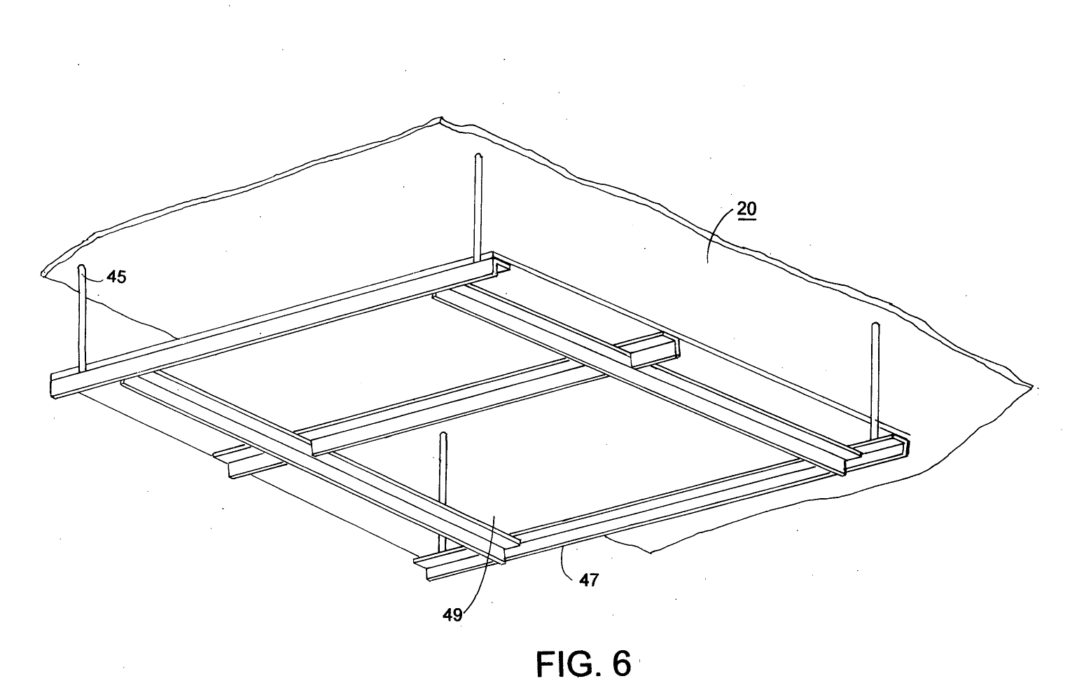

### BRIEF DESCRIPTION OF THE NUMERALS

| NUMERAL | DESCRIPTION |
|---|---|
| 11 | Burn Building |
| 13 | Burn Room |
| 15 | Interior Rooms |
| 17 | Interior Walls |
| 19 | Exterior Walls |
| 20 | Ceiling |
| 21 | Heat Generation Unit |
| 23 | building Entry |
| 24 | Interior Doorway |
| 25 | Side Doorway |
| 27 | Window |
| 29 | Steel Cover |
| 31 | Oil Burner |
| 32 | Outside Cover |
| 33 | Barrier Panel |
| 35 | Hinge or Pivot Point |
| 37 | Cover Edge |
| 39 | Pistons |
| 41 | Cylinders |
| 43 | Safety Switch |
| 45 | Rods |
| 47 | Rack |
| 49 | Pallets |
| 51 | Light |
| 53 | Control Panel |

### DETAILED DESCRIPTION OF THE PREFERRED EMBODIMENT

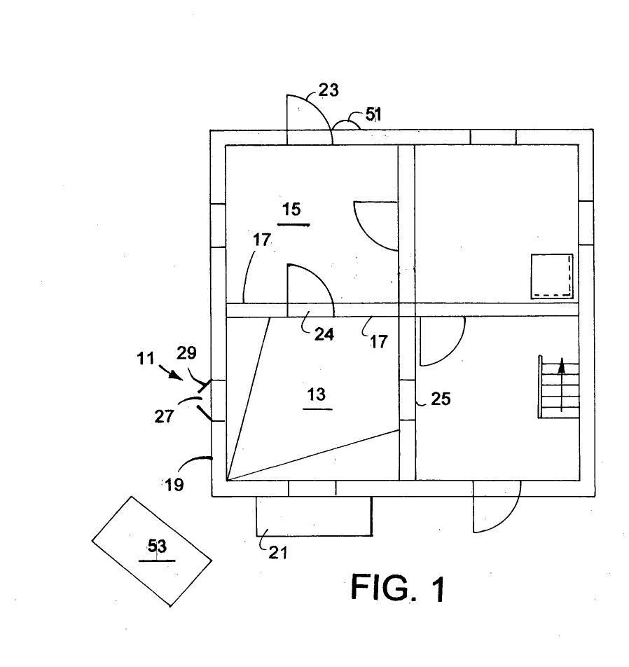

Referring now to FIG. 1, a floor plan for a burn building 11, including a burn room 13 is shown. The burn room 13 has two interior walls 17 and two exterior walls 19 as well as a ceiling 20. On one exterior wall 19, a heat generation unit 21 is mounted. The heat generation unit 21 is mounted substantially midway between one of the exterior walls 19 and one of the interior walls 17. A building entry 23 is located in the exterior wall 19 opposite the heat generation unit 21. An interior doorway 24 is located between the building entry 23 and the heat generation unit 21. A side doorway 25 is located on the interior wall 17, located generally at right angles to the exterior wall 19 on which the heat generation unit 21 is mounted. The exterior wall 19, which is at right angles to the heat generation unit 21, has a window 27 through it which may be closed by the use of a steel cover 29. Preferably, the burn room 19 is essentially square and has a size of eleven and a half feet by eleven and a half feet, with a ceiling height of nine feet.

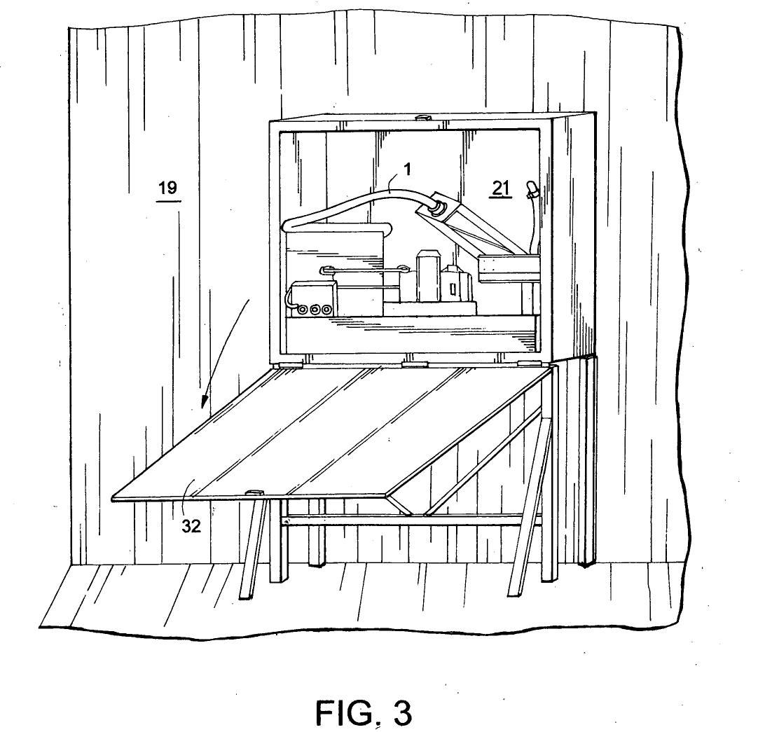

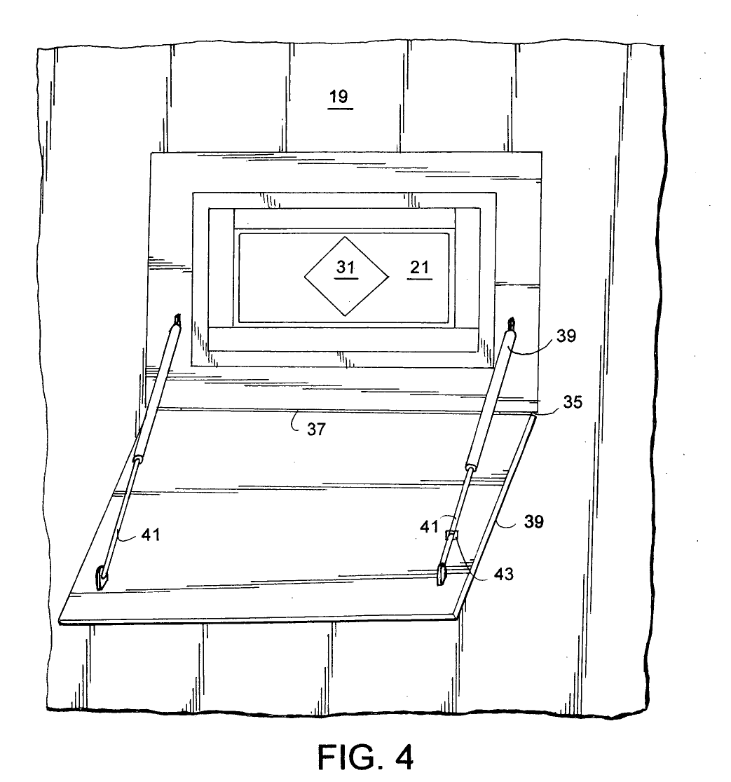

The burn building 11 is constructed of concrete, preferably reinforced poured concrete, as can be readily understood, is necessary to withstand the repeated intense heat applied to the burn building 11. As seen in both FIG. 3 and FIG. 4, an oil burner 31 is part of the heat generation unit 21 to blast a flame of burning heating oil into the burn room 13. In FIG. 3, the outside cover 32 can be seen includes the heat generation unit 21 with the oil burner 31

In FIG. 4, the oil burner 31 can be seen from the interior of the burn room 13. The oil burner 31 is covered when not in use by a barrier panel 33. The barrier panel 33 has a hinge or pivot point 35 along its bottom edge 37 so that the barrier panel 33 will drop down from a vertical or closed position to a horizontal or open position. An air piston 39, which is actuated by a cylinder 41, raises and lowers the barrier panel 33. A safety switch 43 on one piston 39 turns off the oil burner 31 when the barrier panel 33 is rotated to its closed position.

Suspended from the ceiling 20 by rods 45, is a rack 47 made from steel angle members. The rack 47 holds four pallets 49. The pallets 49 used are the well-known wooden pallets made from rough oak. The rack 47 is generally located on the center of the ceiling 20.

The flame from the oil burner 31 is maintained below the pallets 49, but is directed outwardly beneath the pallets 49. The flame preferably does not actually reach the pallets 49. The firefighters undergoing training wait at the building entry 23. A light 51 is mounted at the building entry 23. When the light 51 is green, the firefighters are free to enter the burn room 13 and commence extinguishing the fire. A control panel 53 is located outside the burn building 11. The temperature in the burn room 13 is also monitored at the control panel 53.

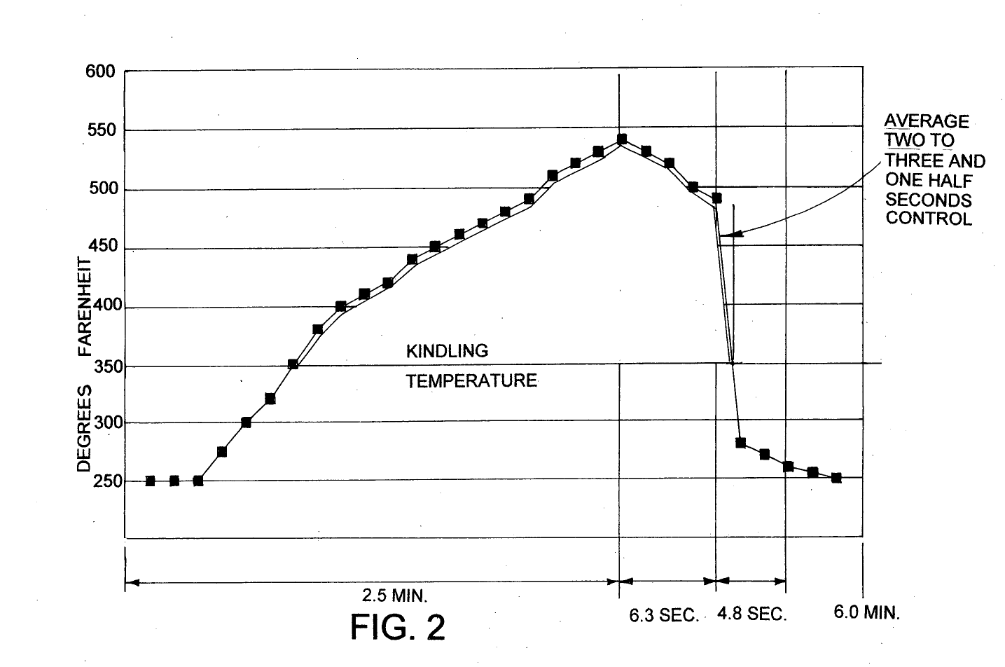

At the commencement of a training session, the oil burner 31 is actuated. As seen in FIG. 2, the temperature in the burn room 13 remains at or below two hundred degrees Fahrenheit for a very brief period and then rises at a rapid rate, moving quickly toward the kindling temperature of the pallets 49, which is at approximately three hundred fifty degrees Fahrenheit. Then the temperature rises to a level just under five hundred fifty degrees. Since the temperature is measured at the level of the rack 47 which is about six inches below the ceiling 20, the temperature at the ceiling 20 is approximated to be six hundred degrees Fahrenheit. When the temperature at the rack 47 approaches five hundred fifty degrees Fahrenheit., the pallets smolder filling the burn room with smoke. The oil burner 31 has a heat output sufficient to heat the burn room 13 to a temperature of five hundred fifty degrees Fahrenheit in less than three minutes.

The time period from cold start up to the temperature approaching five hundred fifty degrees Fahrenheit is approximately two and a half minutes. At that point, the heat drops and a time elapse of six seconds elapses before water is applied. The water application drops the temperature in about three seconds to the temperature of three hundred fifty degrees Fahrenheit, namely the kindling temperature, where the fire is considered to be under control. In a total of four seconds, after the water application, the fire condition is returned to an overhaul phases which means that the fire is under control.

While a preferred embodiment is shown and described herein, it should be understood that the present disclosure is made by way of example only and that variations in the described burn building for training firefighters and its uses are possible within the scope of this disclosure without departing from the subject matter coming within the scope of the following claims, and a reasonable equivalency thereof, which claims I regard as my invention.

1. A burn building for training firefighters comprising:
a burn building including a burn room with a ceiling having at least one doorway into the burn room;
a heat generation unit directed into the burn room;
a barrier panel within the burn room for exposing and covering the heat generation unit;
means to raise and lower the barrier panel;
a control panel for operating the heat generation unit;
a rack suspended from the ceiling; and, means to indicate when to enter the burn room.

2. A burn building according to claim 1, wherein the burn room is essentially square.

3. A burn building according to claim 2, wherein the burn room has four walls, two of the four walls being interior walls and two of the four walls being exterior walls.

4. A burn building according to claim 1, wherein the heat generation unit includes an oil burner.

5. A burn building according to claim 1, wherein the heat generation unit includes an oil burner having a heat output sufficient to heat the burn room to five hundred fifty degrees Fahrenheit in less than three minutes.

6. A burn building according to claim 1, wherein the barrier panel has a lower edge with a pivot point along the lower edge for moving the barrier panel.

7. A burn building according to claim 1, wherein the means to raise and lower the barrier panel is at least one piston and one cylinder.

8. A burn building according to claim 1, where in the means to indicate when to enter the room, is a light mounted at the building entry.

9. A burn building for training firefighters comprising;
a burn building including a burn room with a ceiling and having at least one building entry into the burn building, the burn room having at least one exterior wall;
a heat generation unit mounted in the exterior wall and being directed into the burn room;
a barrier panel within the burn room for exposing and covering the heat generation unit;
a piston and cylinder to raise and lower the barrier panel;
a control panel for operating the heat generation unit;
a rack suspended from the ceiling; and,
means to indicate when to enter the room.

10. A burn building according to claim 9, wherein the burn room is essentially square.

11. A burn building according to claim 9, wherein the heat generation unit includes an oil burner.

12. A burn building for training firefighters comprising;
a burn building with a building entry and with a burn room with a ceiling, the burn room being essentially square and having four walls, two of the four walls being interior walls, and two of the four walls being exterior walls;
a heat generation unit including an oil burner mounted in one of the two exterior walls and being directed into the burn room;
a barrier panel within the burn room for exposing and covering the heat generation unit, the barrier panel having a lower edge with a pivot point along the lower edge;;
at least one piston and cylinder to raise and lower the burner cover, the piston and cylinder being pneumatically actuated;
a control panel for operating the heat generation unit;
a rack constructed of steel angle iron suspended from the ceiling by rods and being mounted generally in the center of the ceiling;
a plurality of wood pallets mounted on the rack; and, a light mounted at the building entry to indicate when to enter the burn building.

13. A burn building according to claim 12, wherein the heat generation unit has a heat output of sufficient heat into the burn room to raise the temperature of the burn room to five hundred fifty degrees Fahrenheit in less than three minutes.

14. A burn building according to claim 12 wherein the control panel monitors the temperature in the burn room.
